(19) United States
(12) Patent Application Publication
(10) Pub. No.: US 2019/0011667 A1
(43) Pub. Date: Jan. 10, 2019

(54) IMAGING LENS ELEMENT, CAMERA MODULE AND ELECTRONIC DEVICE

(71) Applicant: LARGAN PRECISION CO., LTD., Taichung City (TW)

(72) Inventors: Ming-Shun CHANG, Taichung City (TW); Ming-Ta CHOU, Taichung City (TW)

(21) Appl. No.: 15/782,921

(22) Filed: Oct. 13, 2017

(30) Foreign Application Priority Data
Jul. 6, 2017 (TW) 106122733

(51) Int. Cl. G02B 13/00; G02B 1/04; G02B 7/02

(52) U.S. Cl. CPC G02B 13/002; G02B 7/02; G02B 1/041

(57) ABSTRACT

An imaging lens element includes an effective optical section and an outer diameter section. The outer diameter section surrounds the effective optical section and includes an outer diameter curved surface, a withdrawn gate trace and a clearance surface. The outer diameter curved surface and the effective optical section are coaxial with respect to the optical axis. An outer diameter reference plane and the outer diameter curved surface are corresponding to each other with respect to the optical axis. The withdrawn gate trace is withdrawn from the outer diameter reference plane towards the optical axis and includes a gate trace curved surface. The clearance surface connects the outer diameter curved surface and the withdrawn gate trace. On a cross-sectional plane of the imaging lens element, a curvature center of the gate trace curved surface is closer to the optical axis than the gate trace curved surface is thereto.

### RELATED APPLICATIONS

This application claims priority to Taiwan Application Serial Number 106122733, filed Jul. 06, 2017, which is herein incorporated by reference.

### BACKGROUND

### Technical Field

The present disclosure relates to an imaging lens module and a camera module. More particularly, the present disclosure relates to an imaging lens module and a camera module that can be applicable to portable electronic devices.

### Description of Related Art

Nowadays, the camera modules on portable electronic devices usually include a plurality of imaging lens elements, and the outer diameter section of the imaging lens elements are highly reflective for being smooth and bright, just like the effective optical sections. Therefore, the intensity of the reflection light which is incident to the outer diameter section cannot be effectively attenuated, especially for the case when the outer diameter section is disposed with a plane, such as the cut trace plane on the cut trace surface. In this case, after the focused beam reaches the cut trace plane, it may be completely reflected to the imaging surface as a stray light to affect the imaging quality of the camera module.

FIG. 8A is a schematic view of a camera module 8800 in a first prior art, wherein a part of the details of the imaging lens element is omitted. FIG. 8B is a 3-D view of an imaging lens element 8830 of the camera module 8800 in the first prior art. In FIG. 8A and FIG. 8B, the camera module 8800 has an optical axis z and includes the imaging lens element 8830, wherein the imaging lens element 8830 includes an effective optical section 8840 and an outer diameter section 8850. The effective optical section 8840 includes an object-end surface 8841 and an image-end surface 8842. The outer diameter section 8850 surrounds the effective optical section 8840 and includes an outer diameter curved surface 8855, a conventional cut trace 8870, and a clearance surface 8860. The conventional cut trace 8870 includes a cut trace plane 8879. The conventional cut trace 8870 is formed on the clearance surface 8860 when the injection is cut during the imaging lens element 8830 being released, and the plane where the injection is cut is the cut trace plane 8879. Since the cut trace plane 8879 is a plane whose curvature radius is essentially infinite, the clearance surface 8860 is a plane as well, and the total reflection occurs in the imaging lens element 8830 easily (because the imaging lens element has a smaller critical angle), the focused beam L may be completely reflected to the image surface 8807 as the stray light after reaching the cut trace plane 8879, such that the cut trace plane 8879 may become a flare issuing surface to affect the imaging quality of the camera module 8800.

In addition, based on the requirements of the optical imaging and the assembling sizes of the camera module 8800, the optical effective specification (i.e., the minimum diameter of the object-end surface of the effective optical section that can be allowed) that the imaging lens element 8830 needs to satisfy is ψs. The height limitation specification that the imaging lens element 8830 needs to satisfy is Rs, wherein the height limitation specification represents a half of the maximum outer diameter of the imaging lens element that can be allowed, i.e., the maximum curvature radius of the outer diameter curved surface on the cross-sectional plane of the imaging lens element that can be allowed. That is, when the diameter of the object-end surface 8841 of the effective optical section 8840 is ψ, the curvature radius of the outer diameter curved surface 8855 is R, and the imaging lens element 8830 simultaneously satisfies the conditions “ψ>ψs” and “R<Rs”, the imaging lens element 8830 may be determined to satisfy the basic requirements of the camera module 8800 and accordingly applicable to the camera module 8800. For example, the optical effective specification ψs and the height limitation specification Rs that the imaging lens element 8830 needs to satisfy are 4.3 mm and 2.45 mm, respectively.

FIG. 8C is a side view of the imaging lens element 8830 of the camera module 8800 in the first prior art. In particular, FIG. 8C is a side view of the object-end surface 8841 or a cross-sectional view of the imaging lens element 8830 across the conventional cut trace 8870 and having a normal line parallel to the optical axis z. In FIG. 8C, the maximum height difference between the clearance surface 8860 and the outer diameter reference plane P is d, the maximum height difference between the conventional cut trace 8870 and the clearance surface 8860 is h, the width of the conventional cut trace 8870 is Wg in millimeters, the curvature radius of the outer diameter curved surface 8855 is R, and the diameter of the object-end surface 8841 of the effective optical section 8840 is ψ whose value is 3.9 mm that is significantly lower than 4.3 mm (i.e., the value of the optical effective specification ψs that the imaging lens element 8830 needs to satisfy). Accordingly, the conventional cut trace 8870 on the imaging lens elements 8830 in the first prior art is overly large to reduce the range of the effective optical section 8840, such that the imaging lens element 8830 cannot satisfy the optical effective specification ψs while satisfying the height limitation specification Rs.

FIG. 8D is a schematic view of the parameters in FIG. 8C. In FIG. 8D, the width of the clearance surface 8860 is Wc in millimeters, the angle between a first connecting line and a second connecting line is θ2, and the angle between a third connecting line and a fourth connecting line is θ1, wherein each of the clearance surface 8860 and the conventional cut trace 8870 has two ends, the first connecting line connects one of the two ends of the clearance surface 8860 with the optical axis z, the second connecting line connects the other one of the two ends of the clearance surface 8860 with the optical axis z, the third connecting line connects one of the two ends of the conventional cut trace 8870 with the optical axis z, and the fourth connecting line connects the other one of the two ends of the conventional cut trace 8870 with the optical axis z. Further, the injection efficiency parameter is Ig defined as Ig=(Wg×θ2)/θ1, and an injection coefficient is Ic defined as Ic=(Wg×θ2)/(Wc×θ1). The injection efficiency parameter Ig of the imaging lens element 8830 in the first prior art is 0.786 mm, which represents that the molding efficiency of the imaging lens element 8830 is unacceptable, and the yield of the imaging lens element 8830 may be unacceptable as well. The injection coefficient Ic of the imaging lens element 8830 is 0.315, which represents that the injecting time during molding the imaging lens element 8830 is too long to put the imaging lens element 8830 into mass productions.

The following table shows the data defined based on the aforementioned parameters of the imaging lens element 8830 of the camera module 8800 in the first prior art shown in FIG. 8C and FIG. 8D.

First prior art

| | | | |
|---|---|---|---|
| d (mm) | 0.35 | Wc (mm) | 2.493 |
| h (mm) | 0.25 | Wg (mm) | 1.35 |
| ψs (mm) | 4.3 | θ1 (degree) | 62.7 |
| ψ (mm) | 3.9 | θ2 (degree) | 36.5 |
| Rs (mm) | 2.45 | Ig (mm) | 0.786 |
| R (mm) | 2.395 | Ic | 0.315 |

FIG. 9A is a side view of an imaging lens element 9930 in a second prior art, and FIG. 9B is a schematic view of the parameters of FIG. 9A. FIG. 9A is a side view of an object-end surface 9941 of the imaging lens element 9930 or a cross-sectional view of the imaging lens element 9930 across a conventional cut trace 9970 and having a normal line parallel to the optical axis z. In FIG. 9A and FIG. 9B, the camera module (not shown) has the optical axis z and includes the imaging lens element 9930. The imaging lens element 9930 includes an effective optical section 9940 and an outer diameter section 9950. The effective optical section 9940 includes an object-end surface 9941 and an image-end surface (not shown). The outer diameter section 9950 surrounds the effective optical section 9940 and includes an outer diameter curved surface 9955, a conventional cut trace 9970, and a clearance surface 9960. Further, the conventional cut trace 9970 includes a cut trace plane 9979 which is a plane that may become the flare issuing surface easily, and the clearance surface 9960 is a plane as well.

For example, the optical effective specification ψs that the imaging lens element 9930 needs to satisfy is 4.3 mm, the height limitation specification Rs that the imaging lens element 9930 needs to satisfy is 2.45 mm, which are the same as those defined in the first prior art, and the definitions of the parameters in the second prior art are the same as the imaging lens element 8830 of the first prior art. In FIG. 9A and FIG. 9B, the diameter of the object-end surface 9941 of the effective optical section 9940 is ψ whose value is 4.2 mm. Although the value of ψ is higher than the effective optical section 9941 of the first prior art, it is still lower than the optical effective specification ψs (i.e., 4.3 mm) that the imaging lens element 9930 needs to satisfy. Moreover, the outer diameter of the imaging lens element 9930 will be overly large along with extending the range of the effective optical section 9940 of the imaging lens element 9930. That is, the value of the curvature radius R of the outer diameter curved surface 9955 will be correspondingly increased to 2.55 mm, such that the height limitation specification Rs (i.e., 2.45 mm) cannot be satisfied. Meanwhile, the injection efficiency parameter Ig and the injection coefficient Ic show that the molding quality of the imaging lens element 9930 is unacceptable and the time for molding the imaging lens element 9930 is too long. Further, when the size of the injecting inlet (which is proportional to the width Wg of the conventional cut trace 9970) of the imaging lens element 9930 is too small, the molding quality of the effective optical section 9940 may be unacceptable as well. For example, a wrinkle 9990 may occur on the effective optical section 9940 to affect the optical features of the imaging lens element 9930 after the effective optical section 9940 is molded.

The following table shows the data of the parameters of the imaging lens element 9930 in the second prior art shown in FIG. 9A and FIG. 9B.

Second prior art

| | | | |
|---|---|---|---|
| d (mm) | 0.25 | Wc (mm) | 2.202 |
| h (mm) | 0.15 | Wg (mm) | 0.9 |
| ψs (mm) | 4.3 | θ1 (degree) | 51.2 |
| ψ (mm) | 4.2 | θ2 (degree) | 22.1 |
| Rs (mm) | 2.45 | Ig (mm) | 0.388 |
| R (mm) | 2.55 | Ic | 0.176 |

To sum up, the conventional cut trace in the prior arts makes it difficult for the imaging lens element to satisfy the current requirements of the camera modules. Therefore, it is crucial to design a cut trace structure of the imaging lens element that can reduce the stray light while satisfying the specifications of the camera modules.

### SUMMARY

The present disclosure provides an imaging lens element, in order from an optical axis to a periphery, including an effective optical section and an outer diameter section. The outer diameter section surrounds the effective optical section and includes an outer diameter curved surface, a withdrawn gate trace, and a clearance surface. The outer diameter curved surface and the effective optical section are coaxial with respect to the optical axis, and an outer diameter reference plane and the outer diameter curved surface are corresponding to each other with respect to the optical axis. The withdrawn gate trace is withdrawn from the outer diameter reference plane towards the optical axis and comprising a gate trace curved surface. The clearance surface is connected with the outer diameter curved surface and the withdrawn gate trace. On a cross-sectional plane of the imaging lens element, which is across the withdrawn gate trace and has a normal direction parallel to the optical axis, a curvature center of the gate trace curved surface is closer to the optical axis than the gate trace curved surface is to the optical axis. A curvature radius of the gate trace curved surface is r, a curvature radius of the outer diameter curved surface is R, a maximum height difference between the clearance surface and the outer diameter reference plane is d, a maximum height difference between the withdrawn gate trace and the clearance surface is h, and the following conditions are satisfied: 0.60<r/R<1.35; and 0.01 mm<d-h<0.18 mm.

The present disclosure provides a camera module including the aforementioned imaging lens element.

The present disclosure provides an electronic device including the aforementioned camera module and an image sensor disposed on an image surface of the camera module.

### BRIEF DESCRIPTION OF THE DRAWINGS

The present disclosure can be more fully understood by reading the following detailed description of the embodiment, with reference made to the accompanying drawings as follows:

FIG. 1A is a 3-D view of an imaging lens element of the 1st embodiment of the present disclosure;

FIG. 1B is a front view of the imaging lens element of the 1st embodiment;

FIG. 1C is a side cross-sectional view based on the line 1C-1C in FIG. 1B,

FIG. 1D is a schematic view of the parameters in FIG. 1C;

FIG. 1 E is another schematic view of the parameters in FIG. 1C;

FIG. 2A is a schematic view of an imaging lens element of the 2nd embodiment of the present disclosure;

FIG. 2B is a schematic view of the parameters of FIG. 2A;

FIG. 2C is another schematic view of the parameters of FIG. 2A;

FIG. 3A is a schematic view of an imaging lens element of the 3rd embodiment of the present disclosure;

FIG. 3B is a schematic view of the parameters of FIG. 3A;

FIG. 3C is another schematic view of the parameters of FIG. 3A;

FIG. 4 is a schematic view of a camera module of the 4th embodiment of the present disclosure;

FIG. 5A is a schematic view of an electronic device of the 5th embodiment of the present disclosure;

FIG. 5B is another schematic view of the electronic device of the 5th embodiment of the present disclosure;

FIG. 5C is a block diagram of the electronic device of the 5th embodiment;

FIG. 6 is a schematic view of an electronic device according to the 6th embodiment of the present disclosure;

FIG. 7 is a schematic view of an electronic device according to the 7th embodiment of the present disclosure;

FIG. 8A is a schematic view of a camera module in a first prior art, wherein a part of the details of the imaging lens element is omitted;

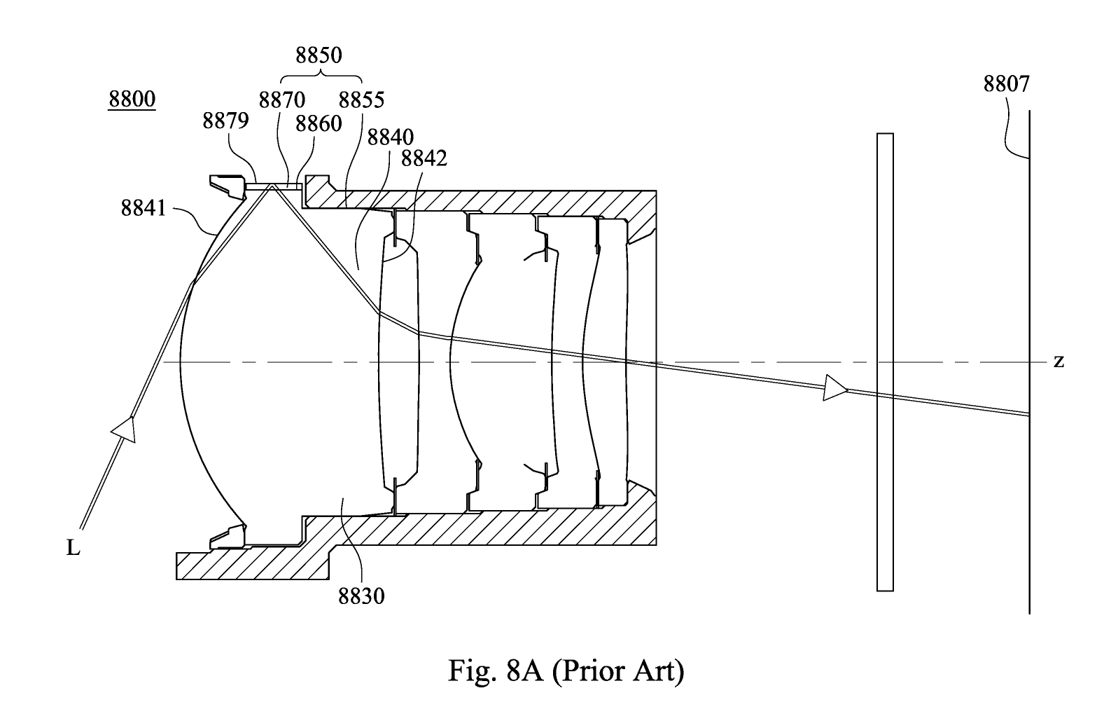

FIG. 8B is a 3-D view of an imaging lens element of the camera module in the first prior art;

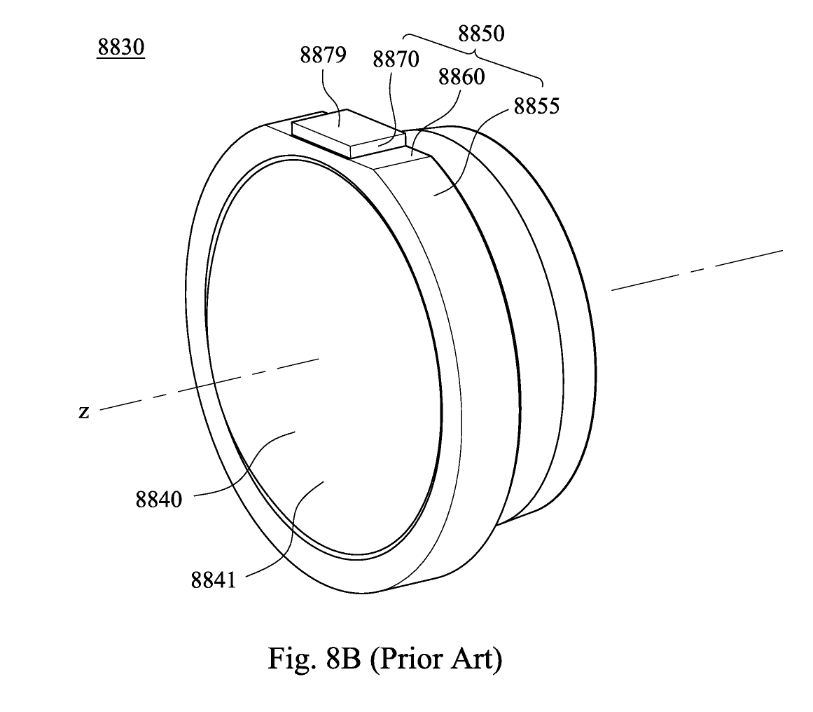

FIG. 8C is a side view of the imaging lens element of the camera module in the first prior art;

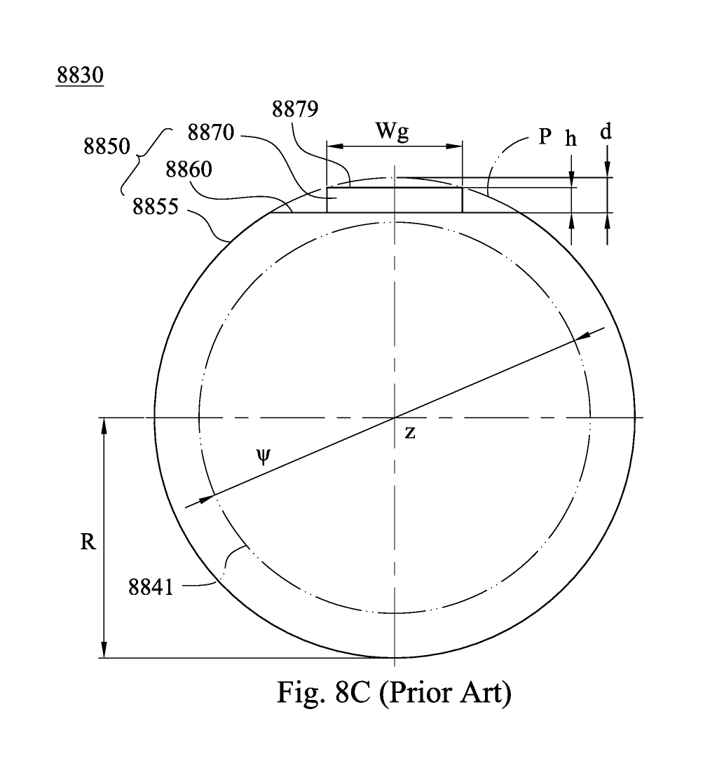

FIG. 8D is a schematic view of the parameters in FIG. 8C;

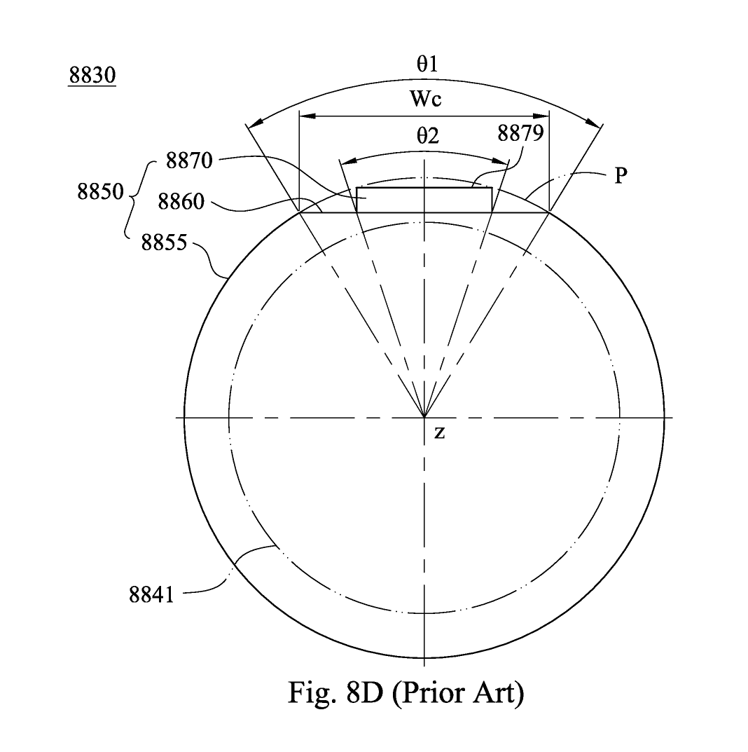

FIG. 9A is a side view of an imaging lens element in a second prior art; and

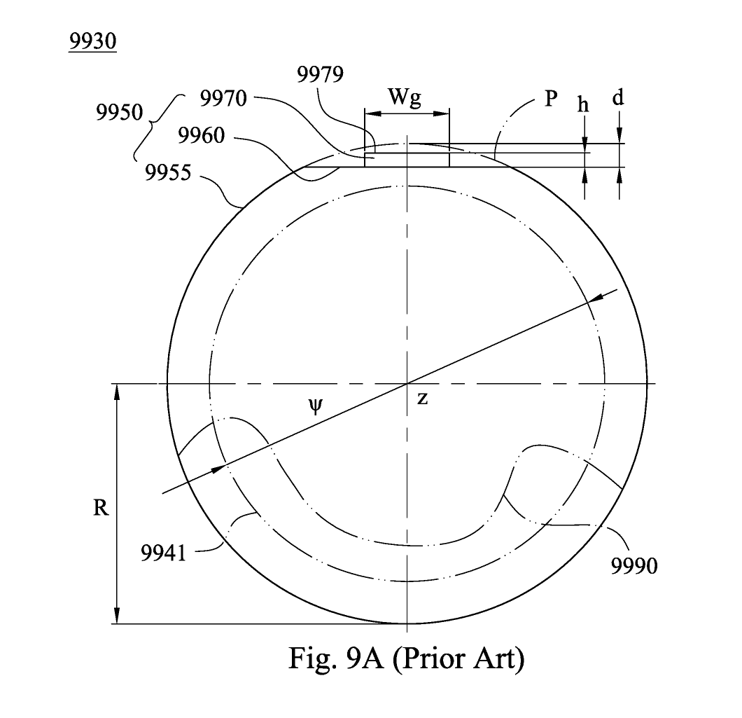

FIG. 9B is a schematic view of the parameters of FIG. 9A.

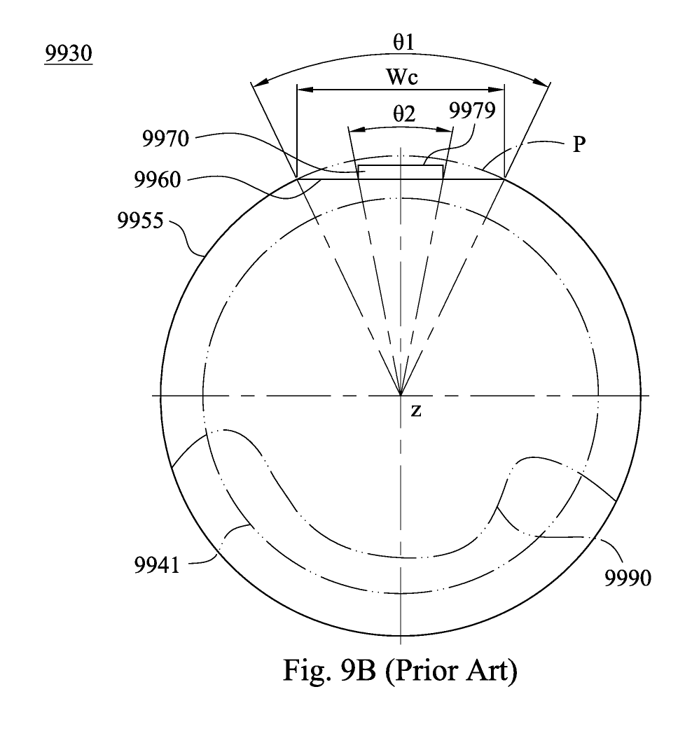

### DETAILED DESCRIPTION

### 1st Embodiment

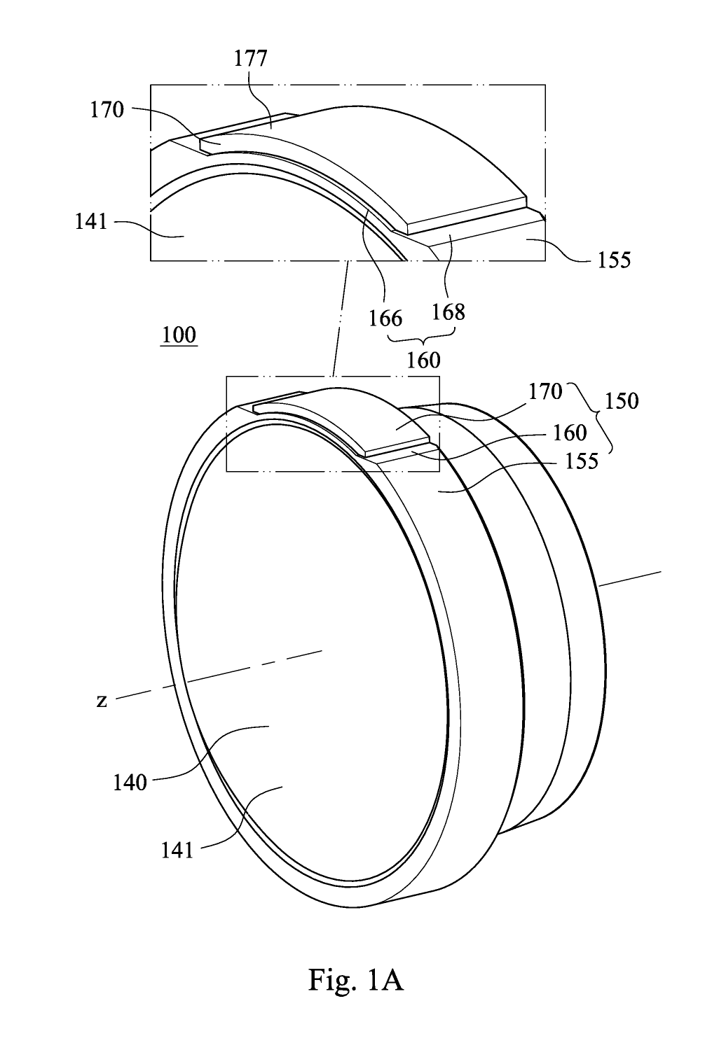

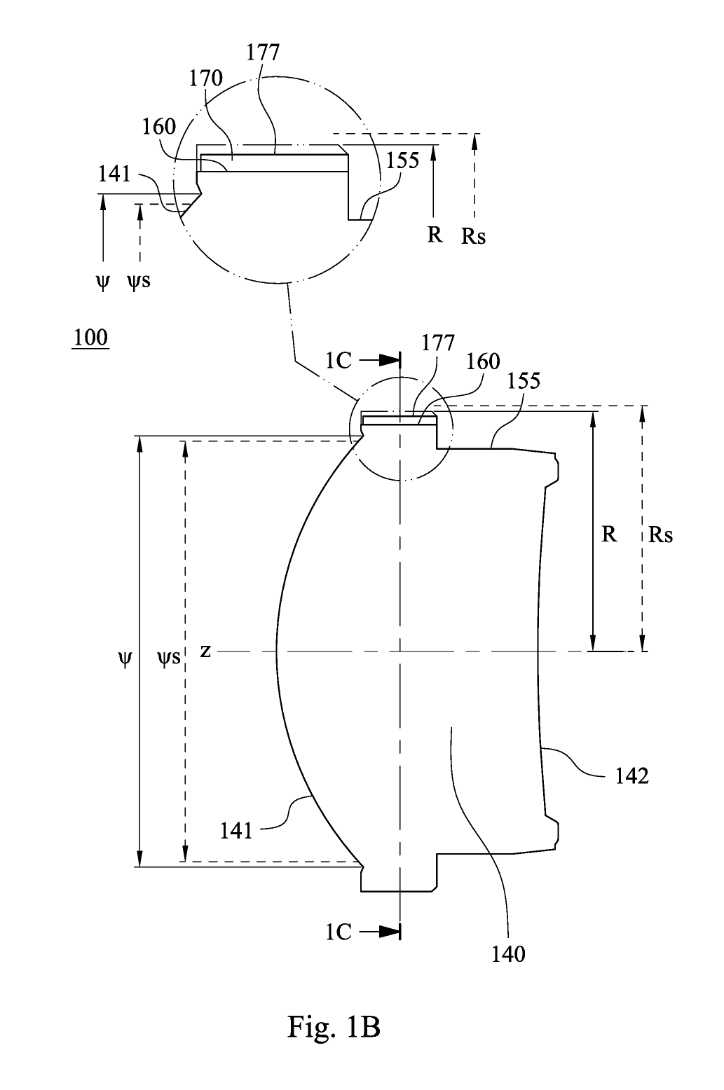

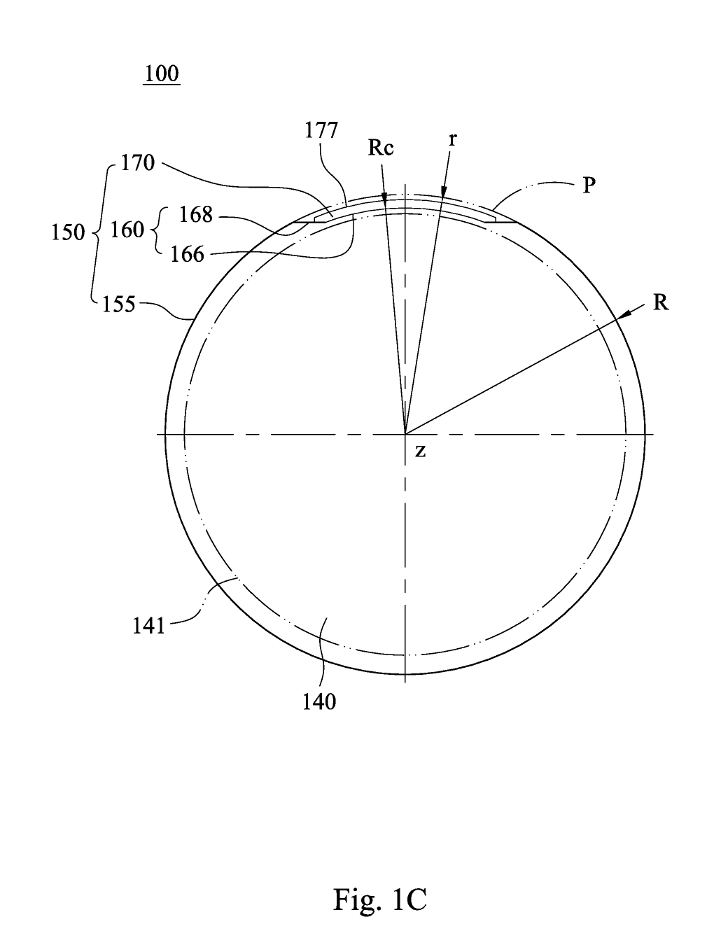

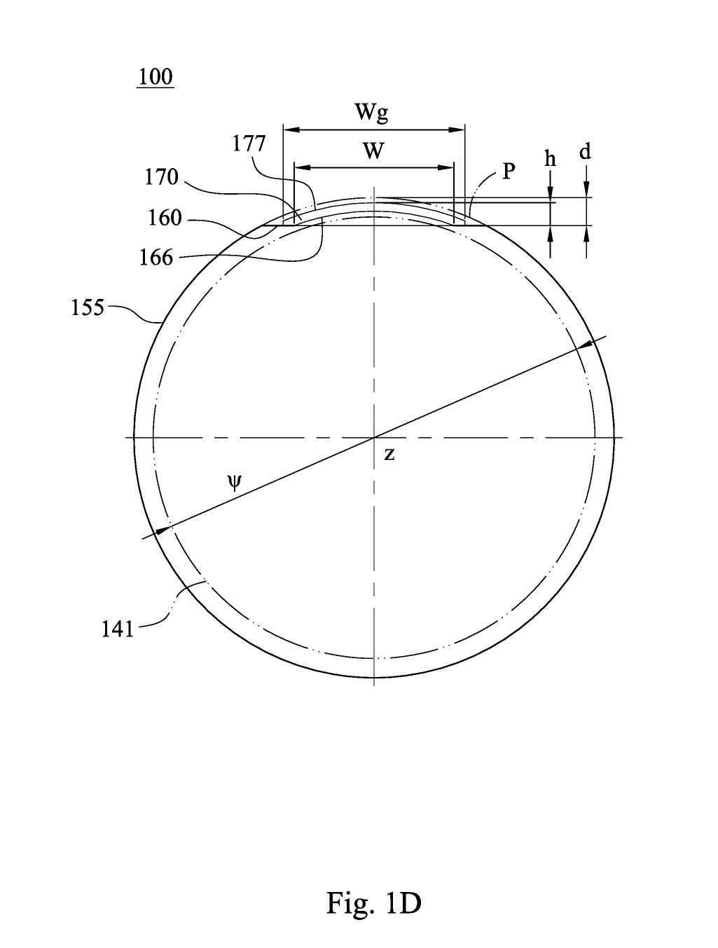

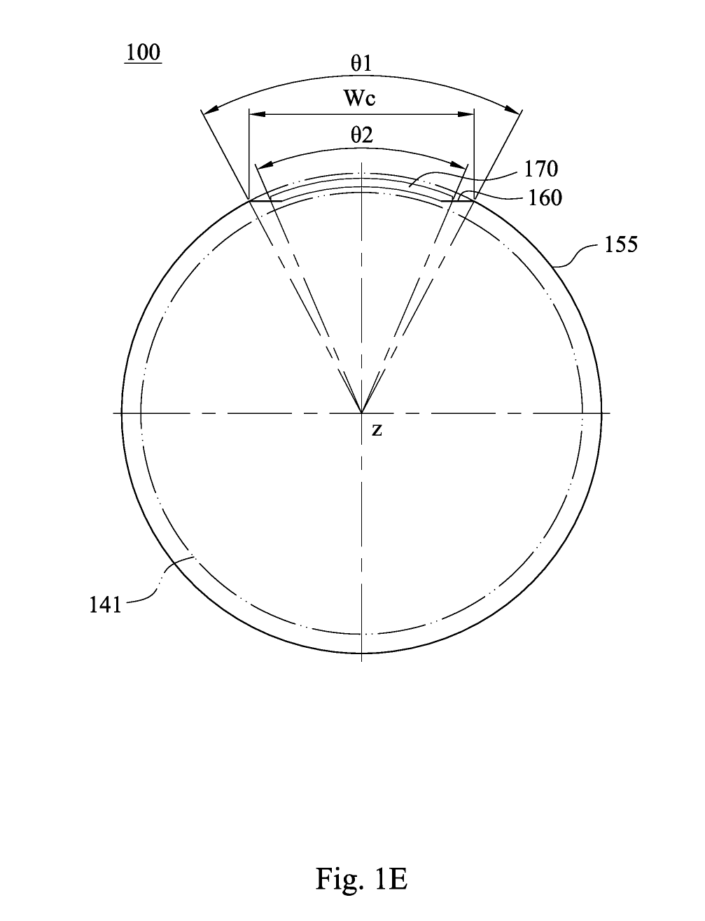

FIG. 1A is a 3-D view of an imaging lens element 100 of the 1st embodiment of the present disclosure, and FIG. 1B is a front view of the imaging lens element 100 of the 1st embodiment. In FIG. 1A and FIG. 1B, the imaging lens element 100 includes, in order from an optical axis z to a periphery, an effective optical section 140 and an outer diameter section 150.

In detail, the imaging lens element 100 may be one of a plurality of imaging lens elements in a camera module (not shown), and based on the requirements of the optical imaging and the assembling sizes of the camera module, the optical effective specification (i.e., the minimum diameter of the object-end surface of the effective optical section that can be allowed) that the imaging lens element 100 needs to satisfy is ψs. The height limitation specification that the imaging lens element 100 needs to satisfy is Rs, wherein the height limitation specification represents half of the maximum outer diameter of the imaging lens element that can be allowed, i.e., the maximum curvature radius of the outer diameter curved surface on the cross-sectional plane of the imaging lens element that can be allowed. That is, when a diameter of an object-end surface 141 of the effective optical section 140 is ψ, a curvature radius of the outer diameter curved surface 155 is R, and the imaging lens element 100 simultaneously satisfies the conditions “ψ>ψs” and “R<Rs”, the imaging lens element 100 may be determined to satisfy the requirements of the optical effective specification 104 s and the height limitation specification Rs of the camera module and accordingly applicable to the camera module. In the 1st embodiment, the optical effective specification ψs and the height limitation specification Rs that the imaging lens element 100 needs to satisfy are 4.3 mm and 2.45 mm, respectively. Moreover, it is noted that the values of the optical effective specification ψs and the height limitation specification Rs in the present disclosure are just exemplary, and the present disclosure is not limited thereto.

In the imaging lens element 100 of the 1st embodiment of the present disclosure, the outer diameter section 150 surrounds the effective optical section 140 and includes an outer diameter curved surface 155, a withdrawn gate trace 170, and a clearance surface 160. The outer diameter curved surface 155 and the effective optical section 140 are coaxial with respect to the optical axis z, and an outer diameter reference plane P and the outer diameter curved surface 155 are corresponding to each other with respect to the optical axis z. More specifically, the outer diameter curved surface 155 may be a circle which is essentially closed or almost closed. The radius of the outer diameter reference plane P with respect to the optical axis z is essentially identical to the radius of the outer diameter curved surface 155 with respect to the optical axis z. The clearance surface 160, the withdrawn gate trace 170, and the outer diameter reference plane P are arranged along a radial direction of the optical axis z.

In the 1st embodiment, one side of the outer diameter curved surface 155 has a larger outer diameter, and the other side of the outer diameter curved surface 155 has a smaller outer diameter. More specifically, when the imaging lens element 100 is applied to the camera module, the side of the outer diameter curved surface 155 closer to the imaged object (not shown) has a larger outer diameter, and the other side of the outer diameter curved surface 155 closer to the image surface (not shown) has a smaller outer diameter. The outer diameter curved surface 155 is a closed circle, and the width of the outer diameter curved surface 155 corresponding to the clearance surface 160 is narrower, such that the outer diameter reference plane P which is virtual can be defined. That is, the radius of the outer diameter reference plane P with respect to the optical axis z is essentially identical to the radius of the outer diameter curved surface 155 with respect to the optical axis z, and the outer diameter reference plane P can be combined with the outer diameter curved surface 155 as a circle with uniform width.

The withdrawn gate trace 170 is withdrawn from the outer diameter reference plane P towards the optical axis z and closer to the optical axis z than the outer diameter reference plane P is to the optical axis z. The withdrawn gate trace 170 includes a gate trace curved surface 177, which represents that the gate trace curved surface 177 is a curved surface having a curvature radius instead of a plane with an essentially infinite curvature radius. The gate trace curved surface 177 may be the plane where the injection is cut. Accordingly, the surface shape of the withdrawn gate trace 170 is different from a plane, which reduces the stray light reflected by the cut traces thereof.

The clearance surface 160 is connected with the outer diameter curved surface 155 and the withdrawn gate trace 170. Since the clearance surface 160 is used to design the position of the injecting inlet of the mold of the imaging lens element 100 and form the withdrawn gate trace 170 on the clearance surface 160 by cutting the injection when the imaging lens element 100 is released, the features of the clearance surface 160 are not only related to the exposed surface thereof, but also related to the unexposed surfaces thereof occupied by the withdrawn gate trace 170. Therefore, the clearance surface 160 mentioned in the present disclosure represents the whole continuous plane including the exposed surface and the unexposed surface occupied by the withdrawn gate trace 170. Accordingly, the gate trace curved surface 177 having the curvature radius may effectively reduce the volume of the imaging lens element 100 occupied by the clearance surface 160. Under the premise of reducing the volume of the withdrawn gate trace 170, the usage volume of the clearance surface 160 is reduced as well, and hence the effective optical section 140 which is larger may be formed in the imaging lens element 100 with small size.

FIG. 1C is a side cross-sectional view based on the line 1C-1C in FIG. 1B, FIG. 1D is a schematic view of the parameters in FIG. 1C, and FIG. 1E is another schematic view of the parameters in FIG. 1C. The cross-sectional plane of the imaging lens element 100 in the 1st embodiment represents any of the cross-sectional planes of the imaging lens element 100 across the withdrawn gate trace 170 and having a normal line parallel to the optical axis z, such as those shown in FIG. 1C, FIG. 1D, and FIG. 1E. Further, the cross-sectional planes discussed in the imaging lens element 100 of the 1st embodiment are essentially the same. In other embodiments (not shown) of the present disclosure, the cross-sectional planes of the imaging lens element may be different from each other.

Taking FIG. 1C as an example, on the cross-sectional plane of the imaging lens element 100, a curvature center of the gate trace curved surface 177 is closer to the optical axis z than the gate trace curved surface 177 is to the optical axis z. In the 1st embodiment, the curvature center of the gate trace curved surface 177 is close to the optical axis z, and hence it is not labelled.

Taking FIG. 1C as an example again, on the cross-sectional plane of the imaging lens element 100, when the curvature radius of the gate trace curved surface 177 is r and the curvature radius of the outer diameter curved surface 155 is R, the following condition can be satisfied: 0.60<r/R<1.35. Accordingly, the gate trace curved surface 177 and the outer diameter curved surface 155 may have similar and proper curvature radiuses, which prevents the value of r/R from being too large, such that the flare issuing surface can be avoided. Besides, the value of r/R can be prevented from being too small, such that the size of the imaging lens element 100 will not be too large to be easily damaged. Preferably, the following condition can be satisfied: 0.68<r/R<1.23. In the 1st embodiment, the curvature center of the outer diameter curved surface 155 locates at the optical axis, the curvature radius r of all positions on the gate trace curved surface 177 are essentially the same, and the curvature radius R of all positions on the outer diameter curved surface 155 are essentially the same. In other embodiments (not shown) of the present disclosure, the curvature radius of the gate trace curved surface and the curvature radius of the outer diameter curved surface may depend on the positions thereof while satisfying the aforementioned conditions of r/R.

In FIG. 1D, when a maximum height difference between the clearance surface 160 and the outer diameter reference plane P is d, and a maximum height difference between the withdrawn gate trace 170 and the clearance surface 160 is h, the following condition can be satisfied: 0.01 mm<d-h<0.18 mm. Accordingly, the parameter (d-h) having a smaller value may reduce the waste of the clearance surface 160. Preferably, the following condition can be satisfied: 0.01 mm<d-h<0.08 mm. Further, the clearance surface 160 may include a curved surface, a plane, or both. When the clearance surface 160 at least has a plane as discussed in the 1st embodiment, the directions of the maximum height difference d and the maximum height difference h are determined based on the normal direction of the plane of the clearance surface 160. That is, the maximum height difference d is the maximum height from the plane of the clearance surface 160 to the outer diameter reference plane P, and the maximum height difference h is the maximum height from the plane of the clearance surface 160 to the withdrawn gate trace 170. In other embodiments (not shown) of the present disclosure, when the clearance surface is merely a curved surface, on the cross-sectional plane of the imaging lens element, the directions of the maximum height difference d and the maximum height difference h are determined based on the normal direction of the connecting line between two ends of the clearance surface. That is, the maximum height difference d is the maximum height from the connecting line between two ends of the clearance surface to the outer diameter reference plane, and the maximum height difference h is the maximum height from the connecting line between two ends of the clearance surface to the withdrawn gate trace.

Specifically, in FIG. 1B, the imaging lens element 100 may be a plastic imaging lens element, and both of the object-end surface 141 and an image-end surface 142 of the effective optical section 140 may be aspheric. When the imaging lens element 100 is applied to the camera module, the object-end surface 141 of the effective optical section 140 faces the imaged object, and the image-end surface 142 of the effective optical section 140 faces the image surface. Accordingly, the mass productions of the imaging lens element 100 with great imaging quality can be facilitated. In addition, the range of the object-end surface 141 of the effective optical section 140 is marked up in FIG. 1C to FIG. 1E, instead of the range shown in the cross-sectional plane of the effective optical section 140 shown in FIG. 1C to FIG. 1E.

As exemplarily shown in FIG. 1C, the clearance surface 160 may include a clearance curved surface 166 on the cross-sectional plane of the imaging lens element 100. When the curvature radius of the clearance curved surface 166 is Rc, and the curvature radius of the outer diameter curved surface 155 is R, the following condition can be satisfied: 0.7<Rc/R<1.4. By replacing the clearance surface of the plane in the prior art with the clearance curved surface 166 of the clearance surface 160, the intensity of the stray light reflected by the clearance surface 160 may be reduced. In the 1st embodiment, the curvature center (not labelled) of the clearance curved surface 166 is close to the optical axis z, and the curvature radius Rc of each positions on the clearance curved surface 166 is essentially the same. In other embodiments (not shown) of the present disclosure, the whole clearance surface may be a clearance curved surface, i.e., the clearance surface does not include the plane, and the curvature radius of the clearance curved surface may depend on the positions thereof.

In FIG. 1C, on the cross-sectional plane of the imaging lens element 100, when the curvature radius of the gate trace curved surface 177 is r, and the curvature radius of the clearance curved surface 166 is Rc, the following condition can be satisfied: 0.5<r/Rc<1.5. Accordingly, gate trace curved surface 177 and the clearance curved surface 166 may have similar and proper curvature radiuses, which reduces the complexity of manufacturing the mold and improves the dimensional precision of the design of the injection inlet.

In FIG. 1A to FIG. 1C, the clearance surface 160 may include the plane 168 and the clearance curved surface 166. In the 1st embodiment, each of the two ends of the clearance surface 160 may be disposed with the plane 168. The planes 168 on the two ends of the clearance surface 160 may be identical and symmetrical to each other, and the clearance curved surface 166 locates between the planes 168. The withdrawn gate trace 170 extends from the clearance curved surface 166 toward the planes 168, i.e., the withdrawn gate trace 170 occupies a part of the clearance curved surface 166 of the clearance surface 160 and a part of the planes 168.

In FIG. 1A and FIG. 1B, the side of the withdrawn gate trace 170 corresponding to the object-end surface 141 and the side of the withdrawn gate trace 170 corresponding to the image-end surface 142 may be withdrawn from the clearance surface 160 or aligned with the clearance surface 160. In the 1st embodiment, the side of the withdrawn gate trace 170 corresponding to the object-end surface 141 is slightly withdrawn from the clearance surface 160, and the side of the withdrawn gate trace 170 corresponding to the image-end surface 142 is aligned with the clearance surface 160.

The clearance surface 160 may include the clearance curved surface 166, wherein both of the clearance surface 160 and the clearance curved surface 166 include an exposed surface and an unexposed surface occupied by the withdrawn gate trace 170. A proportion of the clearance curved surface 166 in the clearance surface 160 may be over 50%. Accordingly, the clearance surface 160 may be prevented from overly compressing the range of the effective optical section 140. Preferably, the proportion of the clearance curved surface 166 in the clearance surface 160 may be over 65%. Accordingly, the range of the imaging lens element 100 other than the effective optical section 140 may be prevented from being too large, and hence the volume of the imaging lens element 100 may be reduced. Further, in the 1st embodiment, the cross-sectional planes of the imaging lens element 100 are essentially the same, the side of the withdrawn gate trace 170 corresponding to the object-end surface 141 is slightly withdrawn from the clearance surface 160, and the side of the withdrawn gate trace 170 corresponding to the image-end surface 142 is aligned with the clearance surface 160. Therefore, in FIG. 1D and FIG. 1 E, on the cross-sectional plane of the imaging lens element 100, the width (i.e., the distance between two ends of the clearance curved surface 166) of the clearance curved surface 166 is W in millimeters, the width of the clearance surface 160 (i.e., the distance between two ends of the clearance surface 160) is Wc in millimeters, and the proportion of the clearance curved surface 166 in the clearance surface 160 approximates the value calculated by (W/Wc)×100%.

When the diameter of the object-end surface 141 of the effective optical section 140 is ψ (as shown in FIG. 1D) and on the cross-sectional plane of the imaging lens element 100 (as shown in FIG. 1C), the diameter of the outer diameter curved surface 155 is 2R (i.e., twice of the curvature radius R of the outer diameter curved surface 155), the following condition can be satisfied: 0.83<ψ/2R<0.98. Accordingly, the range that the effective optical section 140 is molded in the range of the outer diameter curved surface 155 may be increased. Preferably, the following condition can be satisfied: 0.86<ψ/2R<0.95. Accordingly, the effective optical section 140 with a larger range may reduce the volume of the outer diameter section 150 of the imaging lens element 100.

In FIG. 1D and FIG. 1 E, on the cross-sectional plane of the imaging lens element 100, when the width of the withdrawn gate trace 170 (i.e., the distance between the two ends of the withdrawn gate trace 170) is Wg in millimeters, an angle between a first connecting line and a second connecting line is θ2, an angle between a third connecting line and a fourth connecting line is θ1, an injection efficiency parameter is Ig defined as Ig=(Wg×θ2)/θ1, the following condition can be satisfied: 0.71 mm<Ig<2.5 mm, wherein each of the withdrawn gate trace 170 and the clearance surface 160 has two ends, the first connecting line connects one of the two ends of the withdrawn gate trace 170 with the optical axis z, the second connecting line connects the other one of the two ends of the withdrawn gate trace 170 with the optical axis z, the third connecting line connects one of the two ends of the clearance surface 160 with the optical axis z, and the fourth connecting line connects the other one of the two ends of the clearance surface 160 with the optical axis z. Accordingly, for the imaging lens element 100 having the effective optical section 140 with a larger range, the injection efficiency of the imaging lens element 100 satisfying the numerical range of the injection efficiency parameter Ig is better, and hence the imaging lens element 100 with lower quality is less possible to be produced. Preferably, the following condition can be satisfied: 0.82 mm<Ig<2.0 mm. Accordingly, the numerical range of the injection efficiency parameter Ig is more precise for the requirements of the mass productions of the imaging lens element 100.

In FIG. 1D and FIG. 1 E, on the cross-sectional plane of the imaging lens element 100, when the width of the withdrawn gate trace is Wg in millimeters, the angle between the first connecting line and the second connecting line is θ2, the width of the clearance surface is Wc in millimeters, the angle between the third connecting line and the fourth connecting line is θ1, an injection coefficient is Ic defined as Ic=(Wg×θ2)/(Wc×θ1), the following condition can be satisfied: 0.35<Ic<0.95. Accordingly, the imaging lens element 100 satisfying the numerical range of the injection coefficient Ic may accelerate the injection of the injection molding process and shorten the injecting duration.

Further, on the cross-sectional plane of the imaging lens element 100 as shown in FIG. 1C, the angle between the first connecting line (which connects one of the two ends of the withdrawn gate trace 170 with the optical axis z) and the second connecting line (which connects the other one of the two ends of the withdrawn gate trace 170 with the optical axis z) is θ2, wherein the two ends of the withdrawn gate trace 170 are the positions where the withdrawn gate trace 170 is connected with the exposed surface of the clearance surface 160. Besides, the angle between the third connecting line (which the third connecting line connects one of the two ends of the clearance surface 160 with the optical axis z) and the fourth connecting line (which connects the other one of the two ends of the clearance surface 160 with the optical axis z) is θ1, wherein the two ends of the clearance surface 160 are the positions where the clearance surface 160 is connected with the outer diameter curved surface 155.

The following Table 1 shows the data defined based on the aforementioned parameters of the imaging lens element 100 in the 1st embodiment shown in FIG. 1B and FIG. 1E. Further, imaging lens element 100 satisfies both of the conditions “ψ>ψs” and “R<Rs”, i.e., the imaging lens element 100 satisfies the optical effective specification ψs and the height limitation specification Rs of the camera module.

TABLE 1
1st embodiment

| | | | |
|---|---|---|---|
| d (mm) | 0.279 | θ1 (degree) | 55.9 |
| h (mm) | 0.229 | θ2 (degree) | 46.3 |
| ψs (mm) | 4.3 | r/R | 0.98 |
| ψ (mm) | 4.406 | d − h (mm) | 0.050 |
| Rs (mm) | 2.45 | ψ/2R | 0.92 |
| R (mm) | 2.395 | Rc/R | 0.94 |
| Rc (mm) | 2.2607 | r/Rc | 1.04 |
| r (mm) | 2.345 | Ig (mm) | 1.5 |
| Wc (mm) | 2.245 | Ic | 0.668 |
| W (mm) | 1.593 | (W/Wc) × 100% | 70.95% |
| Wg (mm) | 1.8106 | | |

### 2nd Embodiment

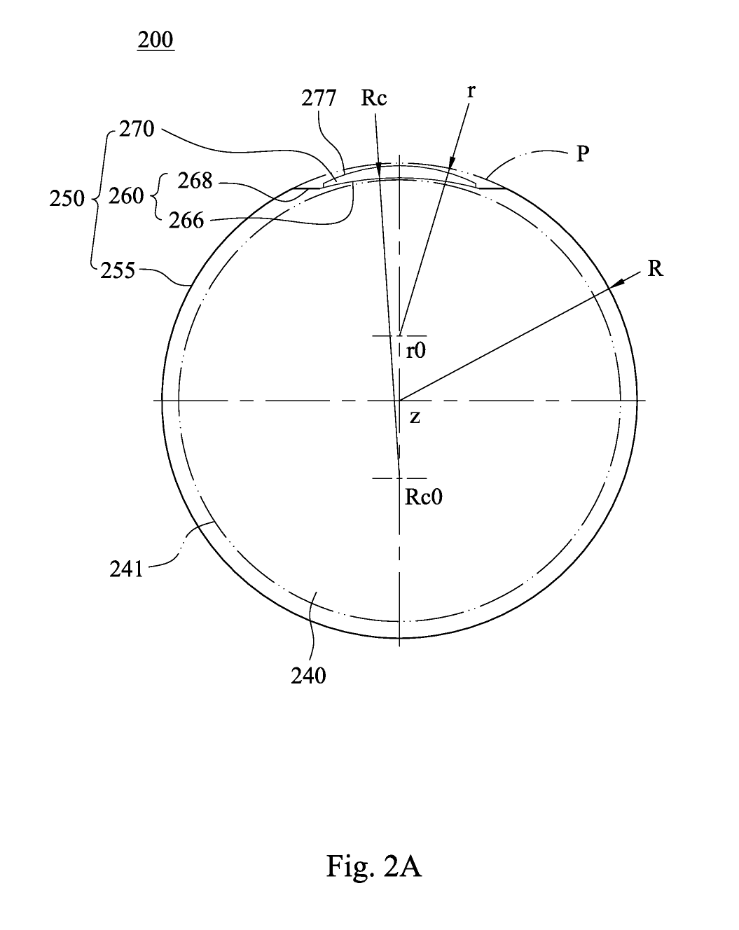

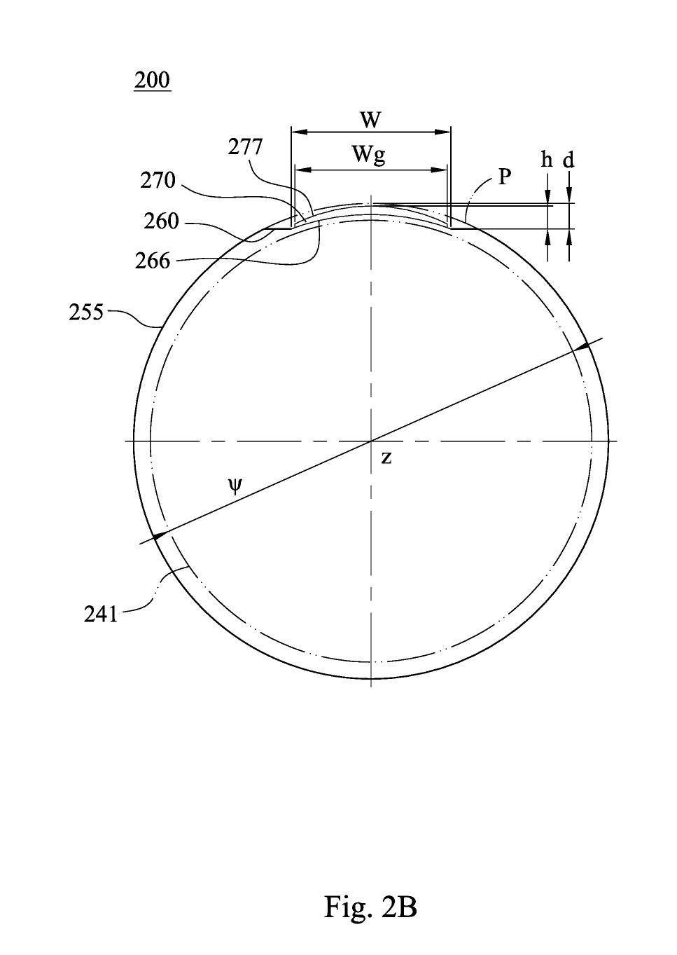

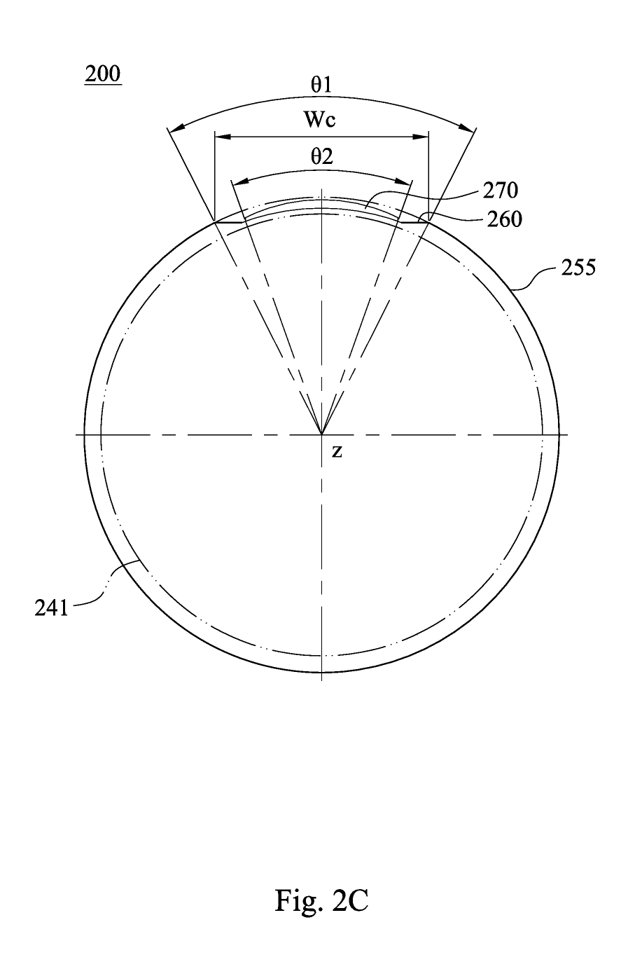

FIG. 2A is a schematic view of an imaging lens element 200 of the 2nd embodiment of the present disclosure. In FIG. 2A, the imaging lens element 200 includes, in order from an optical axis z to a periphery, an effective optical section 240 and an outer diameter section 250.

In the 2nd embodiment, the optical effective specification ψs and the height limitation specification Rs that the imaging lens element 200 needs to satisfy are the same as the imaging lens element 100 in the 1st embodiment.

In addition, other structures of the imaging lens element 200 may be identical to or different from the imaging lens element 100 of the 1st embodiment.

FIG. 2B is a schematic view of the parameters of FIG. 2A, and FIG. 2C is another schematic view of the parameters of FIG. 2A. The cross-sectional plane mentioned in the 2nd embodiment is any of the cross-sectional planes of the imaging lens element 200 across a withdrawn gate trace 270 and has a normal direction parallel to the optical axis z as exemplarily shown in FIG. 2A to FIG. 2C.

In FIG. 2A, based on the imaging lens element 200 of the 2nd embodiment, the outer diameter section 250 surrounds the effective optical section 240 and includes an outer diameter curved surface 255, a withdrawn gate trace 270, and a clearance surface 260. The outer diameter curved surface 255 and the effective optical section 240 are coaxial with respect to the optical axis z, and an outer diameter reference plane P and the outer diameter curved surface 255 are corresponding to each other with respect to the optical axis z. Further, the radius of the outer diameter reference plane P (which is virtual) with respect to the optical axis z is essentially identical to the radius of the outer diameter curved surface 255 with respect to the optical axis z. The clearance surface 260, the withdrawn gate trace 270, and the outer diameter reference plane P are arranged along a radial direction of the optical axis z, and the outer diameter reference plane P can be combined with the outer diameter curved surface 255 as a circle with uniform width.

The withdrawn gate trace 270 is withdrawn from the outer diameter reference plane P towards the optical axis z and closer to the optical axis z than the outer diameter reference plane P is to the optical axis z. The withdrawn gate trace 270 includes a gate trace curved surface 277, which represents that the gate trace curved surface 277 is a curved surface having a curvature radius instead of a plane with an essentially infinite curvature radius.

The clearance surface 260 is connected with the outer diameter curved surface 255 and the withdrawn gate trace 270. The clearance surface 260 mentioned in the present disclosure represents the whole continuous plane including the exposed surface and the unexposed surface occupied by the withdrawn gate trace 270.

On the cross-sectional plane of the imaging lens element 200 as exemplarily shown in FIG. 2A, the curvature center of the gate trace curved surface 277 is r0 which is closer to the optical axis z than the gate trace curved surface 277 is to the optical axis z.

In detail, on the cross-sectional plane of the imaging lens element 200 as exemplarily shown in FIG. 2A, the curvature radius of the gate trace curved surface 277 is r, and the curvature radius r of each positions on the gate trace curved surface 277 is essentially the same. The curvature center of the outer diameter curved surface 255 locates at the optical axis z. The curvature radius of the outer diameter curved surface 255 is R, and the curvature radius R of each position on the outer diameter curved surface 255 is essentially the same. The curvature center of the clearance curved surface 266 is RcO. The curvature radius of the clearance curved surface 266 is Rc, and the curvature radius Rc of each positions on the clearance curved surface 266 is essentially the same.

The imaging lens element 200 is a plastic imaging lens element, and the object-end surface 241 and the image-end surface (not shown) of the effective optical section 240 are aspheric. When the imaging lens element 200 is deployed in the camera module, the object-end surface 241 of the effective optical section 240 faces the imaged object, and the image-end surface of the effective optical section 240 faces the image surface. In addition, the range of the object-end surface 241 of the effective optical section 240 is marked up in FIG. 2A to FIG. 2C, instead of the range of the effective optical section 240 in the cross-sectional plane in FIG. 2A to FIG. 2C.

In FIG. 2A, the clearance surface 260 includes two planes 268 and the clearance curved surface 266. In the 2nd embodiment, two ends of the clearance surface 260 are the planes 268 which are identical and symmetrical to each other, and the clearance curved surface 266 locates between the planes 268. The withdrawn gate trace 270 merely occupies a part of the clearance curved surface 266 of the clearance surface 260.

In FIG. 2B and FIG. 2C, a proportion of the clearance curved surface 266 in the clearance surface 260 may be over 50%. Further, the proportion of the clearance curved surface 266 in the clearance surface 260 may be over 65%. The width (i.e., the distance between two ends of the clearance curved surface 266) of the clearance curved surface 266 is W in millimeters, the width of the clearance surface 260 (i.e., the distance between two ends of the clearance surface 260) is We in millimeters, and the proportion of the clearance curved surface 266 in the clearance surface 260 approximates the value calculated by (W/Wc)×100%.

The following Table 2 shows the data defined based on the aforementioned parameters of the imaging lens element 200 in the 2nd embodiment shown in FIG. 2A to FIG. 2C, wherein the definitions of the parameters are the same as the imaging lens element 100 of the 1st embodiment. Further, the imaging lens element 200 satisfies both of the conditions “ψ>ψs” and “R<Rs”, i.e., the imaging lens element 200 satisfies the optical effective specification ψs and the height limitation specification Rs of the camera module.

TABLE 2
2nd embodiment

| | | | |
|---|---|---|---|
| d (mm) | 0.254 | θ1 (degree) | 53.6 |
| h (mm) | 0.229 | θ2 (degree) | 39.3 |
| ψs (mm) | 4.3 | r/R | 0.72 |
| ψ (mm) | 4.406 | d − h (mm) | 0.025 |
| Rs (mm) | 2.45 | ψ/2R | 0.93 |
| R (mm) | 2.37 | Rc/R | 1.27 |
| Rc (mm) | 3 | r/Rc | 0.57 |
| r (mm) | 1.7 | Ig (mm) | 1.114 |
| Wc (mm) | 2.136 | Ic | 0.522 |
| W (mm) | 1.593 | (W/Wc) × 100% | 74.58% |
| Wg (mm) | 1.52 | | |

### 3rd Embodiment

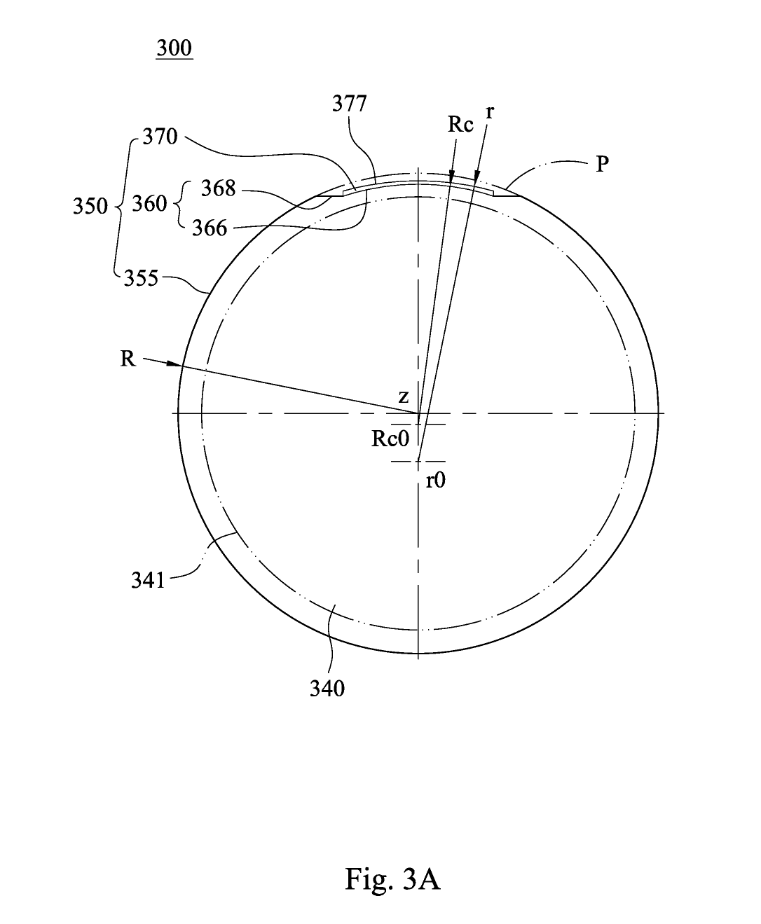

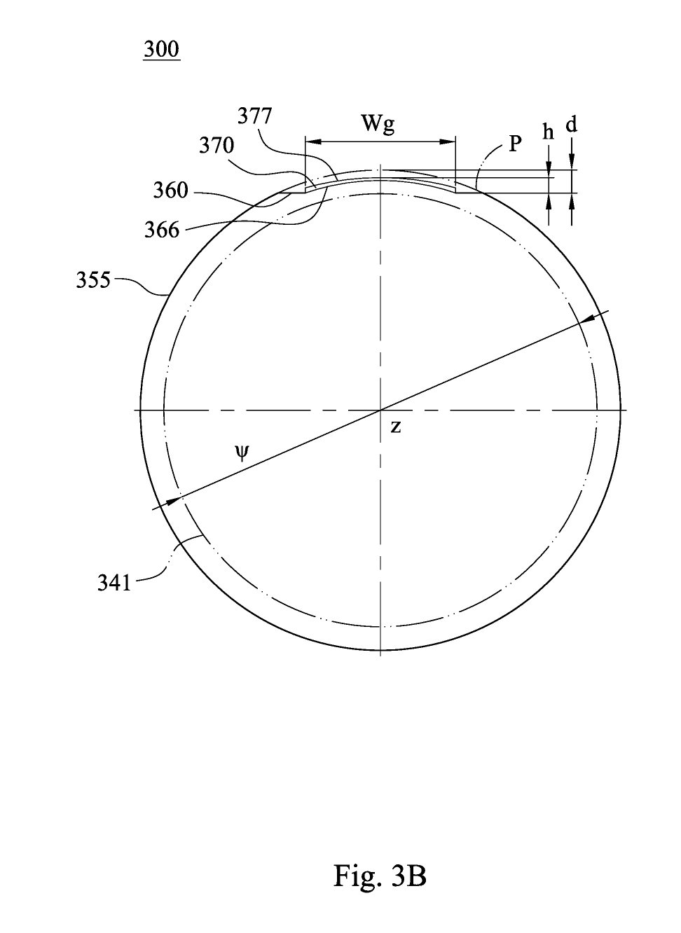

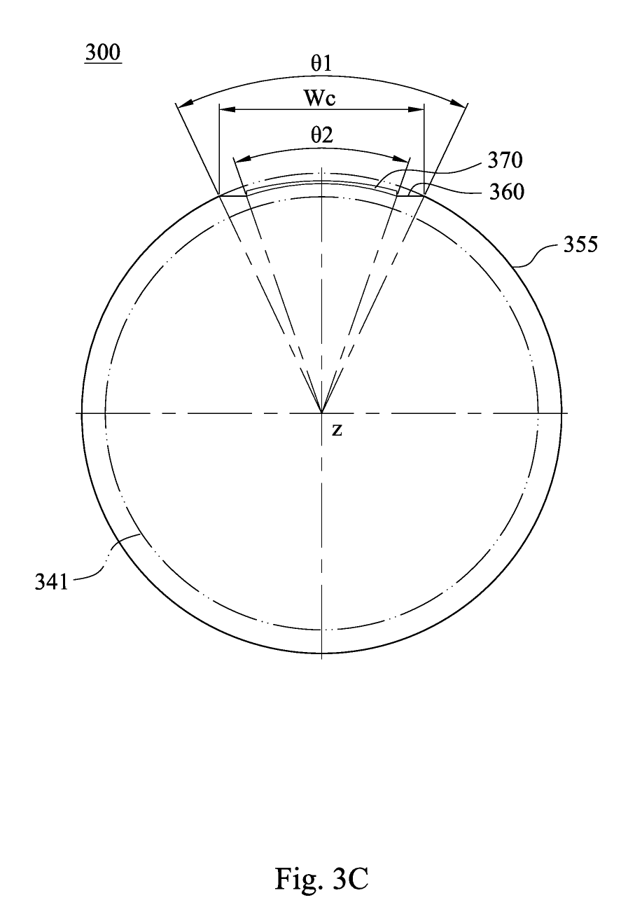

FIG. 3A is a schematic view of an imaging lens element 300 of the 3rd embodiment of the present disclosure. In FIG. 3A, the imaging lens element 300 includes, in order from an optical axis z to a periphery, an effective optical section 340 and an outer diameter section 350.

In the 3rd embodiment, the optical effective specification ψs and the height limitation specification Rs that the imaging lens element 300 needs to satisfy are the same as the imaging lens element 100 in the 1st embodiment. In addition, other structures of the imaging lens element 300 may be identical to or different from the imaging lens element 100 of the 1st embodiment.

FIG. 3B is a schematic view of the parameters of FIG. 3A, and FIG. 3C is another schematic view of the parameters of FIG. 3A. The cross-sectional plane mentioned in the 3rd embodiment is any of the cross-sectional planes of the imaging lens element 300 across a withdrawn gate trace 370 and has a normal direction parallel to the optical axis z as exemplarily shown in FIG. 3A to FIG. 3C.

In FIG. 3A, based on the imaging lens element 300 of the 3rd embodiment, the outer diameter section 350 surrounds the effective optical section 340 and includes an outer diameter curved surface 355, a withdrawn gate trace 370, and a clearance surface 360. The outer diameter curved surface 355 and the effective optical section 340 are coaxial with respect to the optical axis z, and an outer diameter reference plane P and the outer diameter curved surface 355 are corresponding to each other with respect to the optical axis z. Further, the radius of the outer diameter reference plane P (which is virtual) with respect to the optical axis z is essentially identical to the radius of the outer diameter curved surface 355 with respect to the optical axis z. The clearance surface 360, the withdrawn gate trace 370, and the outer diameter reference plane P are arranged along a radial direction of the optical axis z, and the outer diameter reference plane P can be combined with the outer diameter curved surface 355 as a circle with uniform width.

The withdrawn gate trace 370 is withdrawn from the outer diameter reference plane P towards the optical axis z and closer to the optical axis z than the outer diameter reference plane P is to the optical axis z. The withdrawn gate trace 370 includes a gate trace curved surface 377, which represents that the gate trace curved surface 377 is a curved surface having a curvature radius instead of a plane with an essentially infinite curvature radius.

The clearance surface 360 is connected with the outer diameter curved surface 355 and the withdrawn gate trace 370. The clearance surface 360 mentioned in the present disclosure represents the whole continuous plane including the exposed surface and the unexposed surface occupied by the withdrawn gate trace 370.

On the cross-sectional plane of the imaging lens element 300 as exemplarily shown in FIG. 3A, the curvature center of the gate trace curved surface 377 is r0 which is closer to the optical axis z than the gate trace curved surface 377 is to the optical axis z.

In detail, on the cross-sectional plane of the imaging lens element 300 as exemplarily shown in FIG. 3A, the curvature radius of the gate trace curved surface 377 is r, and the curvature radius r of each positions on the gate trace curved surface 377 is essentially the same. The curvature center of the outer diameter curved surface 355 locates at the optical axis z. The curvature radius of the outer diameter curved surface 355 is R, and the curvature radius R of each position on the outer diameter curved surface 355 is essentially the same. The curvature center of the clearance curved surface 366 is Rc0. The curvature radius of the clearance curved surface 366 is Rc, and the curvature radius Rc of each positions on the clearance curved surface 366 is essentially the same.

The imaging lens element 300 is a plastic imaging lens element, and the object-end surface 341 and the image-end surface (not shown) of the effective optical section 340 are aspheric. When the imaging lens element 300 is deployed in the camera module, the object-end surface 341 of the effective optical section 340 faces the imaged object, and the image-end surface of the effective optical section 340 faces the image surface. In addition, the range of the object-end surface 341 of the effective optical section 340 is marked up in FIG. 3A to FIG. 3C, instead of the range of the effective optical section 340 in the cross-sectional plane in FIG. 3A to FIG. 3C.

In FIG. 3A, the clearance surface 360 includes two planes 368 and the clearance curved surface 366. In the 3rd embodiment, two ends of the clearance surface 360 are the planes 368 which are identical and symmetrical to each other, and the clearance curved surface 366 locates between the planes 368. The withdrawn gate trace 370 merely occupies a part of the clearance curved surface 366 of the clearance surface 360.

In FIG. 3B and FIG. 3C, a proportion of the clearance curved surface 366 in the clearance surface 360 may be over 50%. Further, the proportion of the clearance curved surface 366 in the clearance surface 360 may be over 65%. The width (i.e., the distance between two ends of the clearance curved surface 366) of the clearance curved surface 366 is W in millimeters, the width of the clearance surface 360 (i.e., the distance between two ends of the clearance surface 360) is Wc in millimeters, and the proportion of the clearance curved surface 366 in the clearance surface 360 approximates the value calculated by (W/Wc)×100%. In the 3rd embodiment, the values of the width Wg and the width W are the same, and only the width Wg is labelled in FIG. 3B.

The following Table 3 shows the data defined based on the aforementioned parameters of the imaging lens element 300 in the 3rd embodiment shown in FIG. 3A to FIG. 3C, wherein the definitions of the parameters are the same as the imaging lens element 100 of the 1st embodiment. Further, imaging lens element 300 satisfies both of the conditions “ψ>ψs” and “R<Rs”, i.e., the imaging lens element 300 satisfies the optical effective specification ψs and the height limitation specification Rs of the camera module.

TABLE 3
3rd embodiment

| | | | |
|---|---|---|---|
| d (mm) | 0.229 | θ1 (degree) | 50.6 |
| h (mm) | 0.154 | θ2 (degree) | 38.2 |
| ψs (mm) | 4.3 | r/R | 1.17 |
| ψ (mm) | 4.32 | d − h (mm) | 0.075 |
| Rs (mm) | 2.45 | ψ/2R | 0.90 |
| R (mm) | 2.395 | Rc/R | 1.00 |
| Rc (mm) | 2.395 | r/Rc | 1.17 |
| r (mm) | 2.8 | Ig (mm) | 1.132 |
| Wc (mm) | 2.045 | Ic | 0.554 |
| W (mm) | 1.5 | (W/Wc) × 100% | 73.35% |
| Wg (mm) | 1.5 | | |

### 4th Embodiment

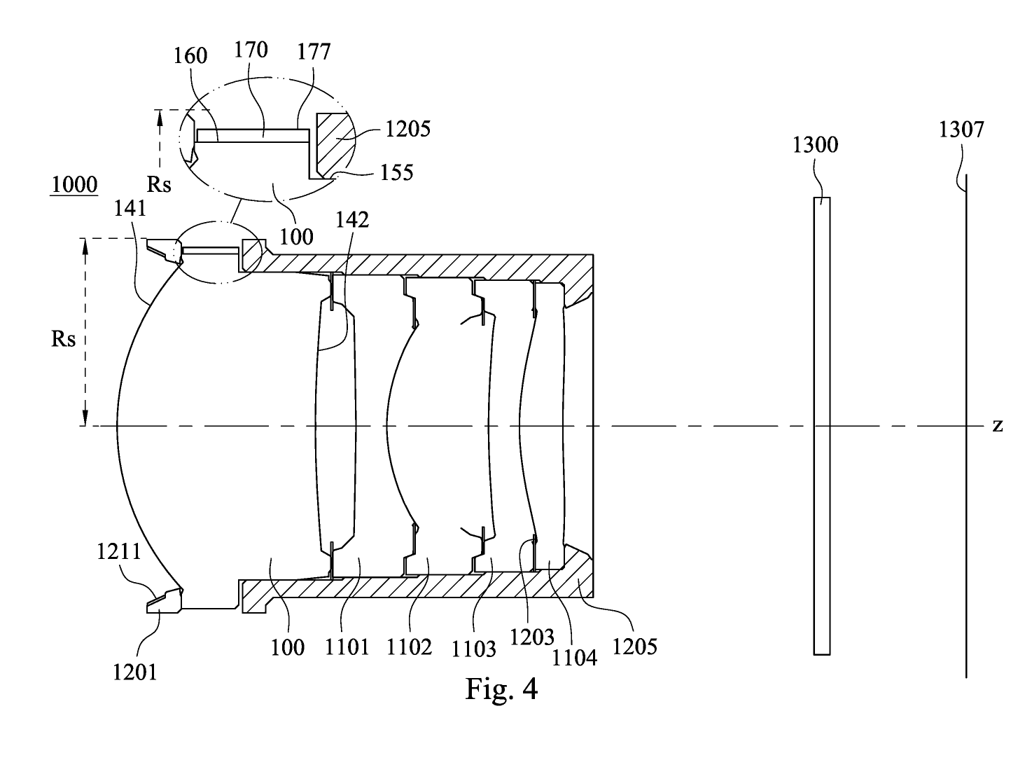

FIG. 4 is a schematic view of a camera module 1000 of the 4th embodiment of the present disclosure, wherein some details of the imaging lens element are omitted in FIG. 4. In FIG. 4, the camera module 1000 includes the imaging lens element 100 of the 1st embodiment of the present disclosure. Accordingly, the stray light of the camera module 1000 may be reduced, and hence the imaging lens element 100 may satisfy the requirements of the specification of the camera module 1000. Other details related to the imaging lens element 100 may be referred to the discussions provided in the 1st embodiment, which will not be repeated herein.

In detail, the camera module 1000 includes a set of imaging lens elements (not labelled), and the camera module 1000 may further include an auto focus component (not shown) and an optical anti-shake component (not shown). The set of the imaging lens elements of the camera module 1000 includes, from the object-end to the image-end, a plurality of imaging lens elements 100, 1101, 1102, 1103, 1104, a glass panel 1300, and an image surface 1307, wherein the number of the lens elements in the set of imaging lens elements is five (i.e., the imaging lens elements 100, 1101, 1102, 1103, and 1104). The imaging lens elements 1101, 1102, 1103, and 1104 are arranged along the optical axis z in a barrel 1205. Besides, the imaging lens elements 1101, 1102, 1103, and 1104 may be the imaging lens elements provided by the present disclosure. In brief, the imaging lens elements 1101, 1102, 1103, and 1104 may include a withdrawn gate trace (not shown) which may include a gate trace curved surface (not shown). Further, the imaging lens elements 1101, 1102, 1103, and 1104 may include other features of the imaging lens element 100 of the 1st embodiment, the imaging lens element 200 of the 2nd embodiment, and the imaging lens element 300 of the 3rd embodiment. The glass panel 1300 may be a cover glass element, a filter, or both, and will not affect the focal length of the set of the imaging lens elements.

Based on the requirements of the optical imaging and the assembling sizes of the camera module 1000, the optical effective specification (i.e., the minimum diameter of the object-end surface of the effective optical section that can be allowed) that the imaging lens element 100 needs to satisfy is 104 s. The height limitation specification that the imaging lens element 100 needs to satisfy is Rs, wherein the height limitation specification represents a half of the maximum outer diameter of the imaging lens element that can be allowed, i.e., the maximum curvature radius of the outer diameter curved surface on the cross-sectional plane of the imaging lens element that can be allowed. In the 4th embodiment, the optical effective specification (ψs) and the height limitation specification (Rs) that the imaging lens element 100 needs to satisfy are 4.3 mm and 2.45 mm, respectively. Based on Table 1 of the 1st embodiment, the imaging lens element 100 simultaneously satisfying the conditions NJ “ψ>ψs” and “R <Rs” (i.e., satisfying the optical effective specification ψs and the height limitation specification Rs) may be applicable to the camera module 1000. Moreover, under the premise of satisfying other requirements of the specifications of the camera module 1000, the imaging lens element 100 may be replaced with the imaging lens element 200 of the 2nd embodiment or the imaging lens element 300 of the 3rd embodiment. Besides, it is should be understood that the values of the optical effective specification ψs and the height limitation specification Rs are just exemplary, not for limiting the present disclosure.

In addition, the set of the imaging lens elements of the camera module 1000 may include other optical elements, such as a fixing ring 1201 disposed at the object side and a light blocking sheet 1203 disposed between the imaging lens elements 1103 and 1104. The inner annular surface of the fixing ring 1201 may include a plurality of stripe structures 1211. Each of the stripe structures 1211 is bar-shaped, and the stripe structures 1211 are radially arranged with respect to the optical axis z to reduce the stray light reflected by the inner annular surface of the fixing ring 1201. The inner annular surface of the light blocking sheet 1203 may include a plurality of microstructures (not shown) for reducing the stray light reflected by the inner annular surface of the light blocking sheet 1203.

### 5th Embodiment

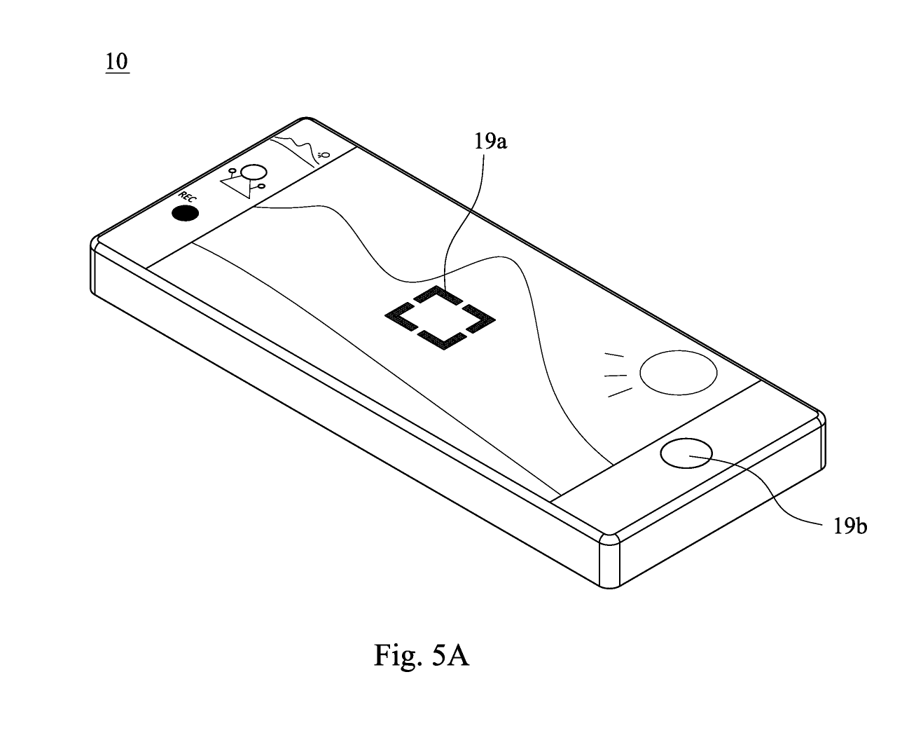

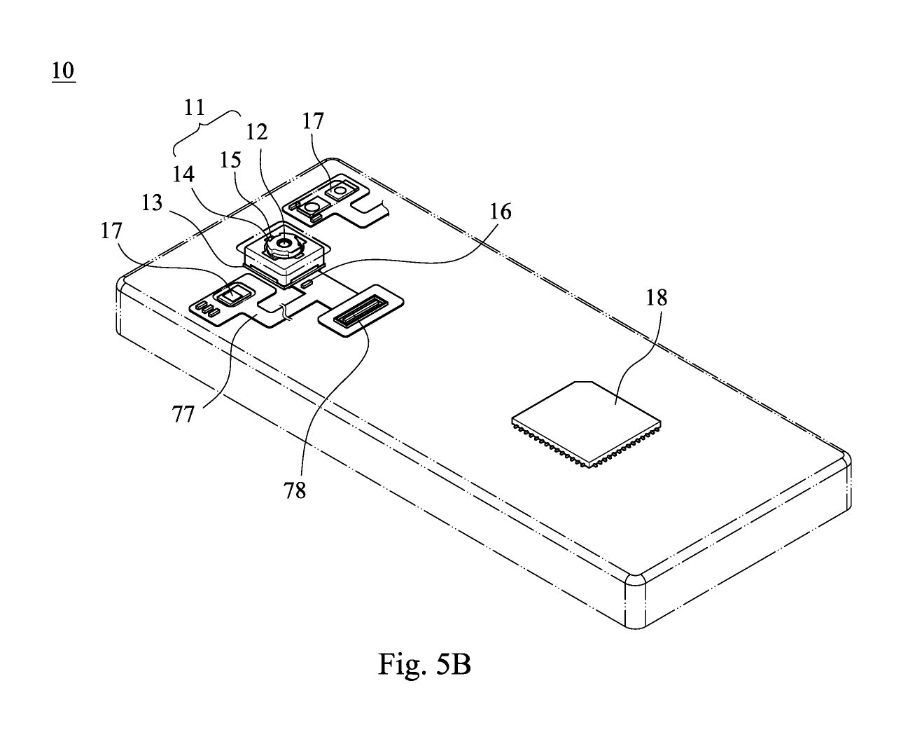

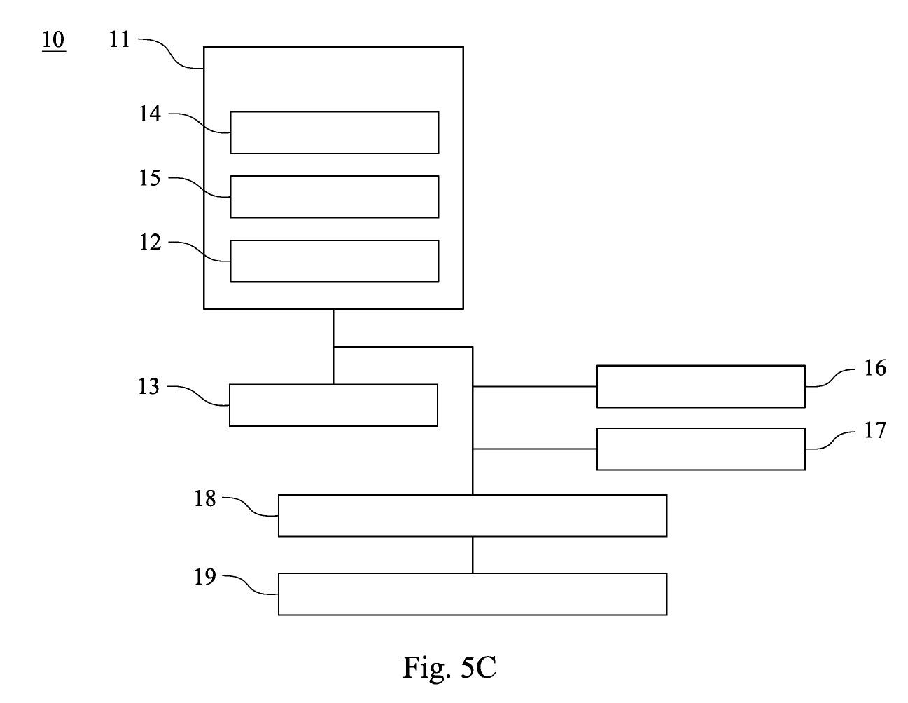

FIG. 5A is a schematic view of an electronic device 10 of the 5th embodiment of the present disclosure, FIG. 5B is another schematic view of the electronic device 10 of the 5th embodiment of the present disclosure, and particularly, FIG. 5A and FIG. 5B are schematic views of a camera of the electronic device 10. In FIG. 5A and FIG. 5B, the electronic device 10 of the 5th embodiment is a smart phone which includes the camera module 11 and an image sensor 13 of the present disclosure, wherein the image sensor 13 is disposed on an image surface (not shown) of the camera module 11. The camera module 11 includes a set 12 of imaging lens elements including the imaging lens elements (not shown) of the present disclosure. Accordingly, a better imaging quality can be achieved, and hence the high specification of imaging requirement of modern electronic devices can be satisfied.

Specifically, the user activates the capturing mode via the user interface 19 of the electronic device 10, wherein the user interface 19 of the 5th embodiment can be a touch screen 19a, a button 19b, etc. At this moment, the camera module 11 collects imaging lights on the image sensor 13 and outputs electronic signals associated with images to an image signal processor (ISP) 18.

FIG. 5C is a block diagram of the electronic device 10 of the 5th embodiment, in particular, the block diagram of the camera of the electronic device 10. In FIG. 5A to FIG. 5C, the camera module 11 can further include an auto focus component 14 and an optical anti-shake component 15 in response to the camera specification of the electronic device 10. Moreover, the electronic device 10 can further include at least one auxiliary optical element 17 and at least one sensing element 16. The auxiliary optical element 17 can be flash modules, infrared distance measurement components, laser focus modules and modules for compensating for color temperatures. The sensing element 16 can have functions for sensing physical momentum and kinetic energies, such as an accelerator, a gyroscope, and a hall effect element, to sense shaking or jitters applied by hands of the user or external environments. As a result, the auto focus component 14 and the optical anti-shake component 15 disposed on the camera module 11 can function to obtain great imaging qualities and facilitate the electronic device 10 according to the present disclosure to have a capturing function with multiple modes, such as taking optimized selfies, high dynamic range (HDR) with a low light source, 4K resolution recording, etc. Additionally, the user can visually see the captured image of the camera through the touch screen 19a and manually operate the view finding range on the touch screen 19a to achieve the auto focus function of what you see is what you get.

Furthermore, in FIG. 5B, the camera module 11, the image sensor 13, the sensing element 16, and the auxiliary optical element 17 can be disposed on a flexible printed circuitboard (FPC) 77 and electrically connected with the associated elements, such as an imaging signal processing element 18, via a connector 78 to perform a capturing process. Since the current electronic devices, such as smartphones, have a tendency of being light and thin, the way of firstly disposing the imaging lens module and related elements on the flexible printed circuitboard and secondly integrating the circuit into the main board of the electronic device via the connector can satisfy the mechanical design of the limited space inside the electronic device and the layout requirements and obtain more margins. The auto focus function of the imaging lens module can be controlled more flexibly via the touch screen of the electronic device. In the 5th embodiment, the electronic device 10 includes a plurality of sensing elements 16 and a plurality of auxiliary optical elements 17. The sensing elements 16 and the auxiliary optical elements 17 are disposed on the flexible printed circuitboard 77 and at least one other flexible printed circuitboard (not labelled particularly) and electrically connected with the associated elements, such as an imaging signal processing element 18, via corresponding connectors to perform a capturing process. In other embodiments (not shown), the sensing elements and the auxiliary optical elements can also be disposed on the main board of the electronic device or carrier boards in other forms according to requirements of the mechanical design and the circuit layout.

In addition, the electronic device 10 can further include, but not be limited to, a wireless communication unit, a control unit, a storage unit, a random access memory, a read-only memory, or the combination thereof.

### 6th Embodiment

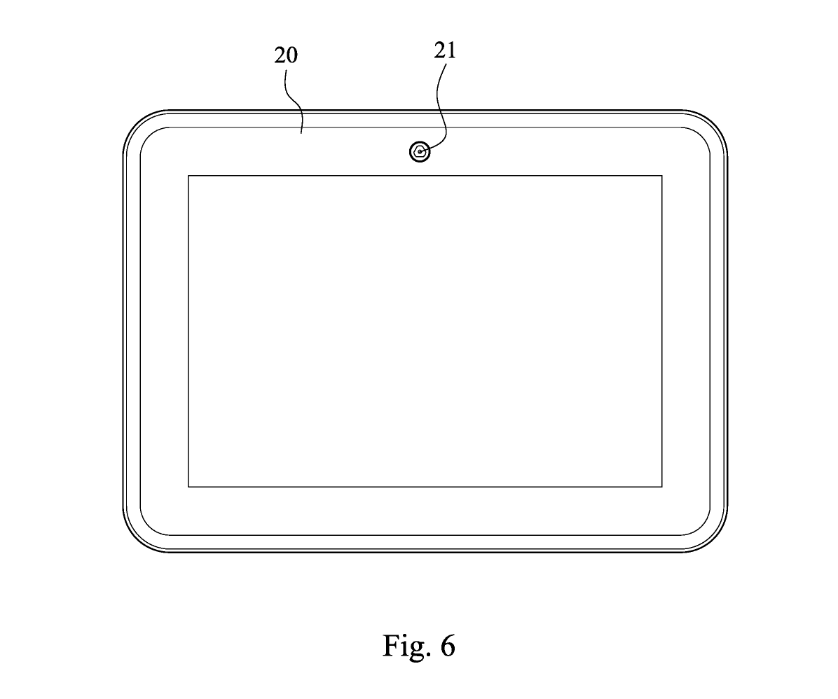

FIG. 6 is a schematic view of an electronic device 20 according to the 6th embodiment of the present disclosure. The electronic device 20 of the 6th embodiment is a tablet, and the electronic device 20 includes a camera module 21 provided by the present disclosure and an image sensor (not shown), wherein the image sensor is disposed on an image surface (not shown) of the camera module 21.

### 7th Embodiment

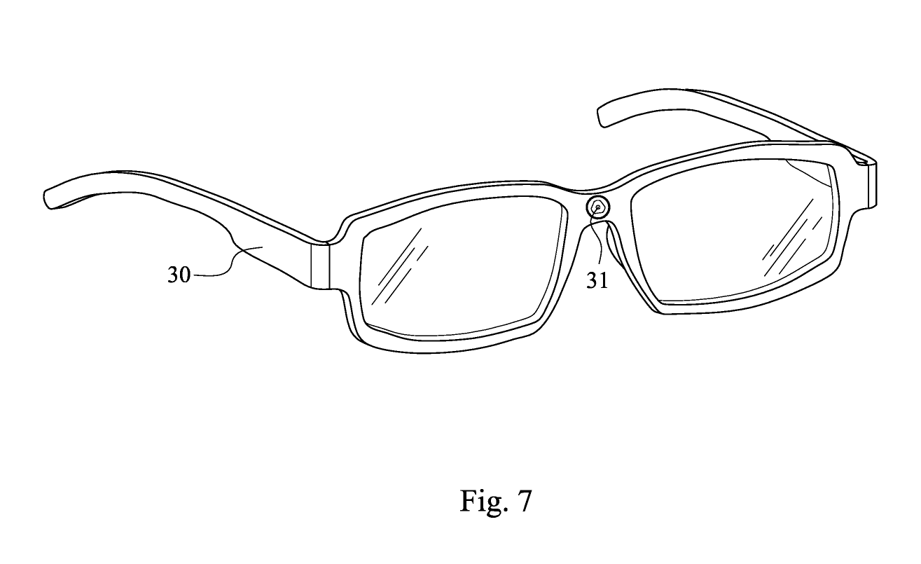

FIG. 7 is a schematic view of an electronic device 30 according to the 7th embodiment of the present disclosure. The electronic device 30 of the 7th embodiment is a wearable device, and the electronic device 30 includes a camera module 31 provided by the present disclosure and an image sensor (not shown), wherein the image sensor is disposed on an image surface (not shown) of the camera module 31.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An imaging lens element, in order from an optical axis to a periphery, comprising:
an effective optical section; and
an outer diameter section surrounding the effective optical section and comprising:
an outer diameter curved surface, wherein the outer diameter curved surface and the effective optical section are coaxial with respect to the optical axis, and an outer diameter reference plane and the outer diameter curved surface are corresponding to each other with respect to the optical axis;
a withdrawn gate trace withdrawn from the outer diameter reference plane towards the optical axis and comprising a gate trace curved surface; and
a clearance surface connected with the outer diameter curved surface and the withdrawn gate trace;
wherein on a cross-sectional plane of the imaging lens element, which is across the withdrawn gate trace and has a normal direction parallel to the optical axis, a curvature center of the gate trace curved surface is closer to the optical axis than the gate trace curved surface is to the optical axis;
wherein a curvature radius of the gate trace curved surface is r, a curvature radius of the outer diameter curved surface is R, a maximum height difference between the clearance surface and the outer diameter reference plane is d, a maximum height difference between the withdrawn gate trace and the clearance surface is h, and the following conditions are satisfied:
0.60<r/R <1.35; and
0.01 mm<d-h<0.18 mm.

2. The imaging lens element of claim 1, wherein the imaging lens element is a plastic imaging lens element, and an object-end surface and an image-end surface of the effective optical section are aspheric.

3. The imaging lens element of claim 2, wherein the clearance surface comprises a plane and a clearance curved surface.

4. The imaging lens element of claim 2, wherein a diameter of the object-end surface of the effective optical section is ψ, a diameter of the outer diameter curved surface on the cross-sectional plane of the imaging lens element is 2R, and the following condition is satisfied:
0.83<ψ/2R<0.98.

5. The imaging lens element of claim 4, wherein the diameter of the object-end surface of the effective optical section is ψ, the diameter of the outer diameter curved surface on the cross-sectional plane of the imaging lens element is 2R, and the following condition is satisfied:
0.86<ψ/2R<0.95.

6. The imaging lens element of claim 1, wherein on the cross-sectional plane of the imaging lens element, the curvature radius of the gate trace curved surface is r, the curvature radius of the outer diameter curved surface is R, and the following condition is satisfied:
0.68<r/R<1.23.

7. The imaging lens element of claim 1, wherein on the cross-sectional plane of the imaging lens element, the maximum height difference between the clearance surface and the outer diameter reference plane is d, the maximum difference between the withdrawn gate trace and the clearance surface is h, and the following condition is satisfied:
0.01 mm<d-h<0.08 mm.

8. The imaging lens element of claim 2, wherein on the cross-sectional plane of the imaging lens element, a width of the withdrawn gate trace is Wg in millimeters, an angle between a first connecting line and a second connecting line is θ2, an angle between a third connecting line and a fourth connecting line is θ1, an injection efficiency parameter is Ig defined as Ig=(Wg×θ2)/θ1, and the following condition is satisfied:
0.71 mm<Ig<2.5 mm;
wherein each of the withdrawn gate trace and the clearance surface has two ends, the first connecting line connects one of the two ends of the withdrawn gate trace with the optical axis, the second connecting line connects the other one of the two ends of the withdrawn gate trace with the optical axis, the third connecting line connects one of the two ends of the clearance surface with the optical axis, and the fourth connecting line connects the other one of the two ends of the clearance surface with the optical axis.

9. The imaging lens element of claim 8, wherein on the cross-sectional plane of the imaging lens element, the width of the withdrawn gate trace is Wg in millimeters, the angle between the first connecting line and the second connecting line is θ2, the angle between the third connecting line and the fourth connecting line is θ1, the injection efficiency parameter is Ig defined as Ig=(Wg×θ2)/θ1, and the following condition is satisfied:
0.82 mm<Ig<2.0 mm.

10. The imaging lens element of claim 2, wherein the clearance surface comprises a clearance curved surface, and on the cross-sectional plane of the imaging lens element, a curvature radius of the clearance curved surface is Rc, the curvature radius of the outer diameter curved surface is R, and the following condition is satisfied:
0.7<Rc/R<1.4.

11. The imaging lens element of claim 10, wherein on the cross-sectional plane of the imaging lens element, the curvature radius of the gate trace curved surface is r, the curvature radius of the clearance curved surface is Rc, and the following condition is satisfied:
0.5<r/Rc<1.5.

12. The imaging lens element of claim 2, wherein the clearance surface comprises a clearance curved surface, and a proportion of the clearance curved surface in the clearance surface is over 50%.

13. The imaging lens element of claim 12, wherein the proportion of the clearance curved surface in the clearance surface is over 65%.

14. The imaging lens element of claim 2, wherein on the cross-sectional plane of the imaging lens element, a width of the withdrawn gate trace is Wg in millimeters, an angle between a first connecting line and a second connecting line is θ2, a width of the clearance surface is Wc in millimeters, an angle between a third connecting line and a fourth connecting line is θ1, an injection coefficient is Ic defined as Ic=(Wg×θ2)/(Wc×θ1), and the following condition is satisfied:
0. 35<Ic<0.95;
wherein each of the withdrawn gate trace and the clearance surface has two ends, the first connecting line connects one of the two ends of the withdrawn gate trace with the optical axis, the second connecting line connects the other one of the two ends of the withdrawn gate trace with the optical axis, the third connecting line connects one of the two ends of the clearance surface with the optical axis, and the fourth connecting line connects the other one of the two ends of the clearance surface with the optical axis.

15. A camera module, comprising:
the imaging lens element of claim 1.

16. An electronic device, comprising:
the camera module of claim 15; and
an image sensor disposed on an image surface of the camera module.
